(19) United States
(12) Patent Application Publication
(10) Pub. No.: US 2011/0016622 A1
(43) Pub. Date: Jan. 27, 2011

(54) FLOOR DRAIN AND METHOD FOR INSTALLING A FLOOR DRAIN

(75) Inventor: Johannes Dallmer, Arnsberg (DE)

Correspondence Address: LERNER GREENBERG STEMER LLP, P O BOX 2480, HOLLYWOOD, FL, 33022-2480, US

(73) Assignee: DALLMER GMBH & CO. KG., Arnsberg (DE)

(21) Appl. No.: 12/570,398

(22) Filed: Sep. 30, 2009

(30) Foreign Application Priority Data
Jul. 27, 2009 (EP) 09 009 669.4

(51) Int. Cl. E03C 1/12; B23P 17/04

(52) U.S. Cl. 4/286; 29/525.11

(57) ABSTRACT

A floor drain has at least a drain channel, a cover, and a fixing device for the releasable connection of the cover and the drain channel. The fixing device includes a latch connected with the cover and moveable with respect to the cover, and an element connected with the drain channel. The latch is adapted to come into releasable connection with the element connected with the drain channel. There is also described a method for installing and a method for de-installing such a floor drain.

### CROSS-REFERENCE TO RELATED APPLICATION

This application claims the priority, under 35 U.S.C. §119, of European patent application EP 09 009 669.4, filed Jul. 27, 2009, which is herewith incorporated by reference in its entirety.

### BACKGROUND OF THE INVENTION

### Field of the Invention

The present invention relates to a floor drain with at least one drain channel, one cover, and one fixing means for the releasable connection of the cover and the drain channel. The invention also pertains to a method for installing and to a method for de-installing the floor drain.

Floor drains are inserted in floors and used, for example, to drain water from wet rooms, such as swimming pools, showers, industrial kitchens etc. The floor drain therefore has the purpose of collecting the liquids present on the floor and draining them to a disposal system.

A floor drain usually comprises a drain channel and a cover. The cover at least partially covers the drain channel and is configured and arranged in such a way that liquid can pass into the drain channel. For this purpose the cover is formed, for example, as a grating, or a gap is left between a closed cover and the drain channel.

The cover must be held and fixed in a predetermined position with respect to the drain channel. For this purpose, mostly, adjusting screws are mounted in the drain channel on which the cover is held. Fixation of the cover is by means of bolts, for example, screwed through the cover into the adjusting screws.

In this context it has proven a drawback that the screw heads are visible from the outside or must be covered by concealment elements, for example. The drawbacks being considered here are of both aesthetic and hygienic nature. Due to the screws, dirt can accumulate in the gaps and steps, wherein the dirt, in turn, can lead to discoloration and germ formation. Moreover, the installation of the cover must be carried out by screwing in the bolts, which requires a certain amount of time and, in particular, tools.

### SUMMARY OF THE INVENTION

It is accordingly an object of the invention to provide a floor drain, which overcomes the above-mentioned disadvantages of the heretofore-known devices and methods of this general type and which provides for a floor drain having a cover which can be installed in a simple manner and wherein, in particular, the risk of dirt accumulation is reduced.

With the foregoing and other objects in view there is provided, in accordance with the invention, a floor drain, comprising:

a drain channel;

a cover disposed to cover said drain channel;

a fixing device configured to releasably connect said cover and said drain channel, said fixing device including a latch connected with said cover and moveable with respect to said cover, and a fixing element connected with said drain channel, and

wherein said latch is configured to enter into a releasable connection with said fixing element connected with said drain channel.

In other words, the objects of the invention and the further object of providing a floor drain channel assembly that is easy to install is achieved by way of the fixing device comprising a latch connected with the cover and moveable with respect to the cover, and an fixing element connected with the drain channel, wherein the latch is configured to come into releasable connection with the element connected with the drain channel. The suggested floor drain does not need screws or similar connecting means to connect the cover and the drain channel. There is therefore no risk of dirt deposition in screw heads or bores. Installation is as well facilitated by the fact that the latch is connected to the cover. For example, screws cannot get lost. Also, no screws need to be inserted in bores which can save installation time.

In accordance with an added feature of the invention, the element connected to the drain channel is an adjusting screw, wherein the adjusting screw has a cylindrical portion and a head with a larger diameter than the cylindrical portion. An adjusting screw is anyway provided to space the cover from the drain channel and can be used to fix the cover, in particular in a direction vertical to the floor of the drain channel, by configuring the cylindrical portion and the head.

In accordance with an additional feature of the invention, the latch comprises a connecting means which is adapted for releasable connection with the adjusting screw, in particular the cylindrical portion of the adjusting screw.

In an advantageous and in particular economic embodiment of the suggested invention it can be provided that the connecting means is configured as a circular cut-out with a lateral opening in the latch, wherein the latch is configured to be resilient in the area of the cut-out and the opening is smaller than the diameter of the cut-out. An undercut is formed by configuration of the cut-out and the opening. Due to its resilient properties, the area of the cut-out can be expanded in a transient manner to enable fitting over the adjusting screw, and can subsequently return to its initial state. Such a connecting means is particularly advantageous for connecting the latch and the adjusting screw, since the connection basically remains intact, i.e. inadvertent releasing of the connection can be essentially excluded.

It is also possible, in particular to facilitate installation, to provide the cut-out with ramps in the area of the opening. The resilient portion of the latch is thus pressed apart in a suitable manner as the latch is operated until the adjusting screw is received in the cut-out. The force expenditure for sliding the latch is thus substantially reduced.

To ensure the least possible friction and best possible predetermination in the sliding motion of the latch with respect to the cover, it can be advantageously provided that the latch and the cover form at least one, preferably two, linear bearings between them.

In an economic and simple embodiment of the linear bearing it can be provided that the linear bearing comprises a cover-side elongate hole and a latch-side bearing part. The latch can thus be guided between the two legs of the cover in the direction of the elongate hole.

To enable simple and directed operation of the latch it can be advantageously provided that the fixing means is equipped with at least one, preferably two, operating means.

The operating means can be advantageously formed as a portion of the latch protruding from the cover. By these means it is possible to operate the latch from outside of the cover.

In a particularly advantageous embodiment of the invention it can be provided that the operating means protrudes from the leg of the cover. Such an arrangement of the operating means contributes, in particular, to optimal concealment of the part of the latch theoretically visible in the installed state, by arranging it in an area between the leg of the cover and the side wall of the drain channel. However, the operating means remains operable by any rod-like object, if there is a suitable distance between the leg and the side wall, i.e. with a tile stop, which is part and parcel of the floor drain kit anyway.

To facilitate installation of the latch as such, it can be provided that the latch is provided with an auxiliary mounting means. In a preferred embodiment the auxiliary mounting means can comprise two elastic arms wherein respectively a latch-side bearing portion is attached and a wing is attached on the end of the arms. By suitably gripping the wings, such as with thumb and forefinger, the latch can be very easily positioned between the legs of the cover and the latch-side bearing portions can be inserted in the cover-side bearing portions, i.e. the corresponding portion of the latch can be inserted into the elongate holes.

With the above and other objects in view there is also provided, in accordance with the invention, a method for installing a floor drain, which method comprises:

providing a floor drain as outline above;

placing the cover on the adjusting screw or screws in the drain channel, wherein the latch is in a first, unfixed state; and

displacing the latch into a fixed state by displacing the one or more operating means toward the adjusting screw.

We also provide for a method of de-installing a floor drain according to the invention. The method comprises the following steps:

displacing the latch into an unfixed state by moving the one or more operating means away from the adjusting screw; and

removing the cover from the adjusting screws or screws out of the drain channel.

The methods are distinguished in a particularly advantageous manner in that the installation or de-installation can be carried out without loose installation means, such as screws. This means that such loose installation means need not be stored, or cannot be displaced or lost. It is also to be expected that the installation or de-installation can be carried out more quickly.

Other features which are considered as characteristic for the invention are set forth in the appended claims.

Although the invention is illustrated and described herein as embodied in a floor drain and method for installing a floor drain, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a portion of a floor drain according to the present invention;

FIG. 2 is a perspective and partially cutaway view of a portion of a floor drain according to the present invention (with cover raised);

FIG. 3 is a perspective view of a portion of a cover, an adjusting screw and a latch of a floor drain according to the present invention;

FIG. 4 is a bottom view of a portion of a cover, an adjusting screw and a latch of a floor drain according to the present invention;

FIG. 5 is a front view of a cover, an adjusting screw and a latch of a floor drain according to the present invention; and

FIG. 6 is a partially cutaway side view of a portion of a floor drain according to the present invention.

### DETAILED DESCRIPTION OF THE INVENTION

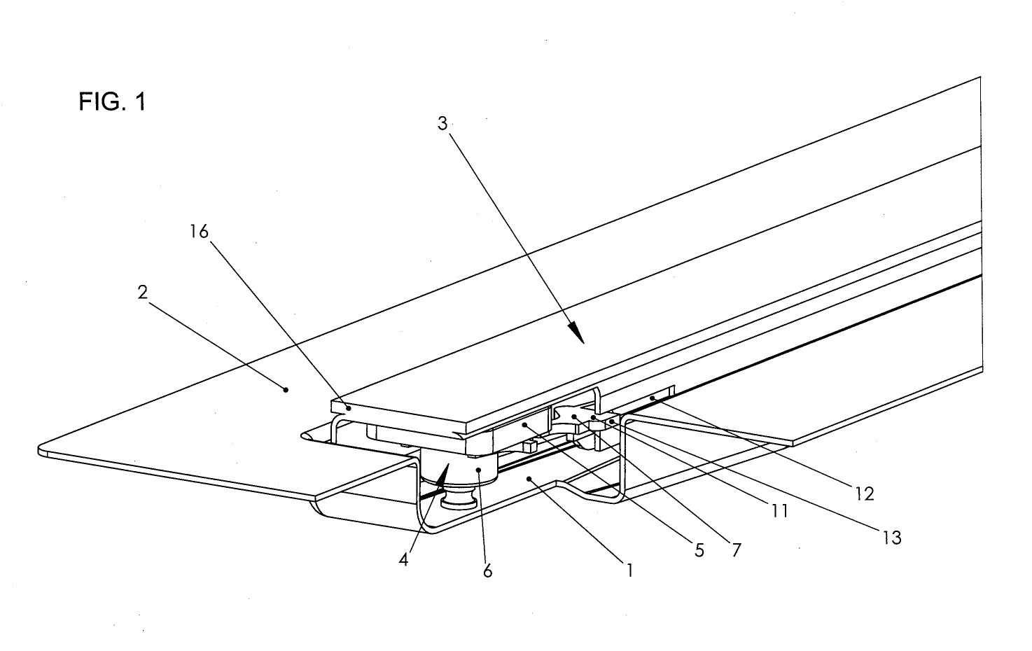

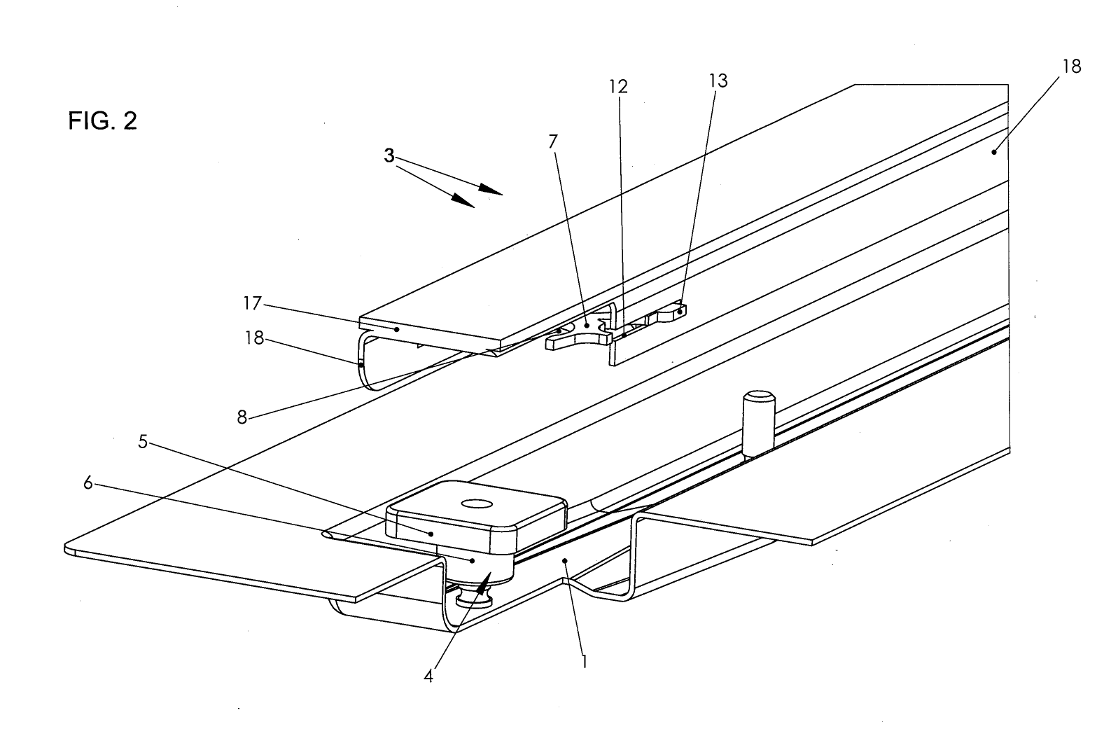

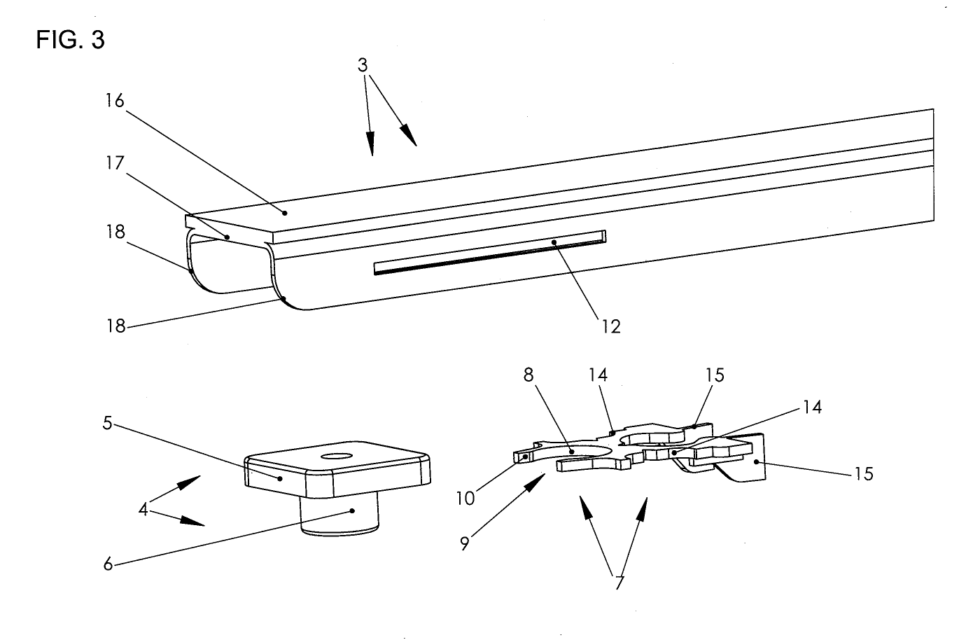

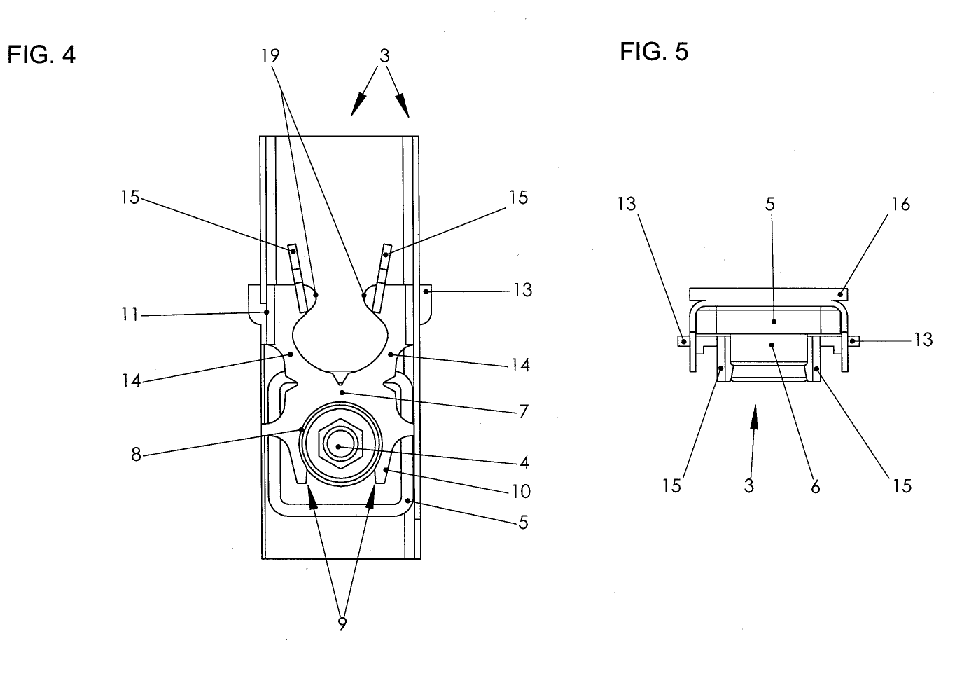

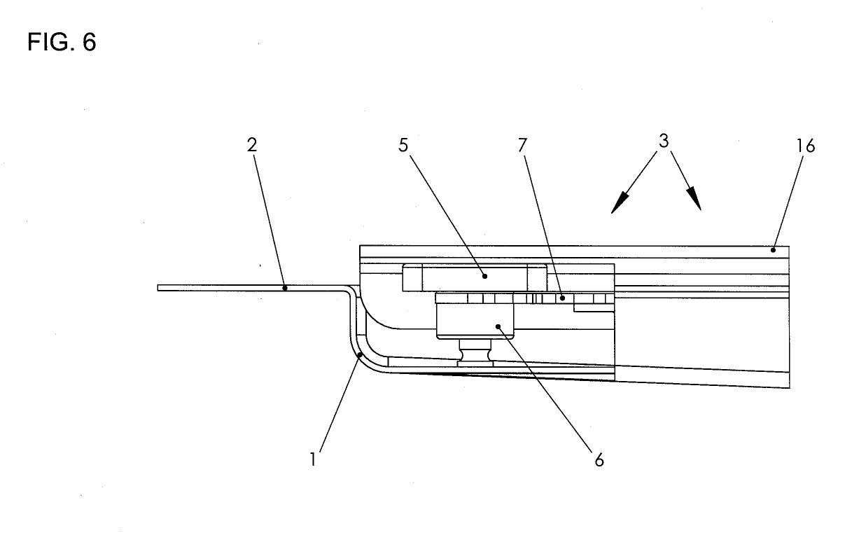

Referring now to the figures of the drawing in detail and first, particularly, to FIG. 1 thereof, there is shown a floor drain according to the present invention comprises a drain channel 1 with a collar 2, a cover 3 and at least one fixing means, or fixing device, for releasably connecting the cover 3 and the drain channel 1. The floor drain also comprises a non-illustrated suitable pipe connection for connection with a drain pipe, the details of which are, however, well known to those of skill in the art and need not be explained in any more detail here.

The configuration of the channel body, i.e. the drain channel 1 and the collar 2 is also sufficiently well known to the person skilled in the art. It is convenient to form the channel body of one piece of noncorroding sheeting, for example by means of well known sheet forming methods. Welded structures of corresponding individual parts are, of course, also conceivable. Distancing elements may be provided below the drain channel 1 for supporting the drain channel 1. The collar 2 is primarily for establishing a connection to the floor structure. Tiles can preferably be placed on the collar.

Depending on the length and shape of the drain channel 1, two or more adjusting screws 4 are provided for supporting the cover above the bottom of the drain channel. The adjusting screws 4 extend from the bottom of the drain channel 1 and basically serve to support the cover 3. The adjusting screw 4 has a head 5 in a cubodial shaped form and a cylindrical portion 6, which will be of importance in the context of the fixing means. The adjusting screws 4 can be made of a plastic material, for example.

The cover 3 is formed here as an elongate section, U-shaped in cross-section, comprising a top surface 17 and two legs 18 vertically extending from the top surface 17. Preferably, the U-shaped section is also made of a noncorroding sheeting material, in particular stainless steel. On the top surface 17, a decorative section 16 is attached. For the decorative section 16, a variety of materials is conceivable, in particular, however, stainless steel. Basically, the decorative section 16 can be dispensed with. For the cover 3, various structures are possible, for example a grating-type surface etc.

The fixing means essentially comprises a latch 7 connected with the cover 3 and displaceable with respect to the cover 3, and an element connected with the drain channel 1. In the embodiment suggested here, this element is formed by the already mentioned adjusting screw 4. Here, other implementations are also conceivable, however, such as bosses in the drain channel 1 or welding beads. Basically, openings in the drain channel 1 would also be possible, in which the latch 7 can be inserted. The latch 7 can come into releasable connection with the adjusting screw 4 and can be operated from outside the cover 3. For realizing the above-mentioned functions, the latch 7 and the cover 3, in particular, have various functional elements.

For releasable connection of the latch 7 with the adjusting screw 4, the latch 7 is equipped with a connecting means. The connecting means is formed, for example, as a circular cut-out 8 in the latch 7, having a lateral opening 9 extending over about ¼ of the circumference. Preferably, the latch 7, in particular the connecting means, is adapted to be suitably resilient, so that the connecting means can be pushed onto the cylindrical portion of the adjusting screw 4, partially embracing it in an end position. For this reason the opening 9 is smaller than the diameter of the cut-out 8. In the area of the opening 9, the connecting means can be provided with ramps 10, so that it can be more easily pushed onto the cylindrical portion 6 of the adjusting screw 4. By means of the undercut, the latch 7 is clamped on the adjusting screw 4 and cannot be released from it by itself. By pushing the latch 7, in particular the connecting means, under the head 5 of the adjusting screw 4, lifting-off of the cover 3 can be prevented.

To provide bearing, in particular for linear guiding, for the latch 7, the latch 7 and the cover 3 form two linear bearings between them. The cover-side part of the linear bearing is formed by an elongate hole 12 in the longitudinal direction of the cover 3. The latch-side part of the linear bearing is formed by a portion of the latch 7 guided in the elongate hole 12. To simplify the description, this portion will be referred to as the latch-side bearing part 11 in the following. Preferably, a linear bearing is provided on each side of the latch 7 so that the latch 7 is received between the two legs 18 of the cover 3 and can be displaced in the longitudinal direction of the cover 3.

To operate the fixing means, operating means 13 are provided, which are accessible from the outside of the cover 3, i.e. the latch 7 arranged within the cover 3 can be displaced from outside by means of the operating means 13. In a simple and economic embodiment, the operating means 13 is formed as a portion of the latch 7, which protrudes to the outside through the elongate hole 12.

To simplify mounting of the latch 7, an auxiliary mounting means is provided. The latch-side bearing part 11 is thus attached to a resilient arm 14. Two arms 14 are thus provided each extending to the first latch-side bearing part 11 and the second latch-side bearing part 11. The arms 14 are arranged in an acute angle with respect to each other so that approximately a V-shaped arrangement of the arms 14 results in a plan view. Furthermore, each arm 14 is provided with a wing 15. By pressing together the wings 15, which can be gripped by thumb and forefinger, for example, the distance between the latch-side bearing parts 11 can be reduced. The wings 15 or the arms 14 can be provided with bosses 19 facing each other. By means of the bosses 19, pressing-together of the wings 15 can be limited and breaking of the resilient arms 14 can be prevented. As soon as the wings 15 are released, the latch-side bearing parts 11 return to their original positions. The wings 15 and the resilient arms 14 facilitate easy mounting of the latch 7 within the cover. For assembly, the latch 7 is gripped at the wings 15 and positioned between the legs 18 of the cover 3 at the level of the longitudinal holes 12. As soon as the wings 15 are released, the operating means 13 protrude from the elongate holes 12 and the latch-side bearing parts 11 are received in the elongate holes 12. The latch 7 is in position and can be used to connect the cover 3 with the drain channel 1. It goes without saying that a tool, such as a pliers, can also be used to operate the wings 15.

The arrangement of the one or more operating means 13 results in a very advantageous way of installing the cover 3 and the drain channel 1. The cover 3 is inserted into the drain channel 1 and held at a predetermined level by the adjusting screw(s) 4. In this state and at this point, the fixing means is in a first, non-fixing state, i.e. the latch 7 is at a distance from the adjusting screw 4. In a subsequent installation step, the latch 7 is displaced toward the adjusting screw 4 into a fixed, second state. For this purpose, the operating means 13 is moved toward the adjusting screw 4. This can be achieved, for example, by a tile stop, which is already part and parcel of the floor drain kit. It is also conceivable, however, that the operating means 13 be operated by any rod-like object, such as a screwdriver.

The de-installation of the cover 3 can also be achieved in a simple manner by reversing the above-illustrated steps. To this end the latch 7 is simply displaced in the opposite direction.

1. A floor drain, comprising:
a drain channel;
a cover disposed to cover said drain channel;
a fixing device configured to releasably connect said cover and said drain channel, said fixing device including a latch connected with said cover and moveable with respect to said cover, and a fixing element connected with said drain channel, and
wherein said latch is configured to enter into a releasable connection with said fixing element connected with said drain channel.

2. The floor drain according to claim 1, wherein said cover has an elongate shape and is U-shaped in cross-section, with a top surface and two legs extending substantially vertically from said top surface.

3. The floor drain according to claim 1, wherein said fixing element is an adjusting screw connected with said drain channel, said adjusting screw has a cylindrical portion and a head with a larger diameter than said cylindrical portion.

4. The floor drain according to claim 3, wherein said latch comprises a connecting means adapted for the releasable connection with said adjusting screw.

5. The floor drain according to claim 4, wherein said connecting means is configured for a releasable connection with said cylindrical portion of said adjusting screw.

6. The floor drain according to claim 4, wherein said connecting means is a circular cut-out with a lateral opening in said latch, wherein said latch is resiliently formed in the area of said cut-out and said opening is smaller than a diameter of said cut-out.

7. The floor drain according to claim 6, wherein said cut-out is formed with ramps in the area of said opening.

8. The floor drain according to claim 1, wherein said latch and said cover form at least one linear bearing therebetween.

9. The floor drain according to claim 8, wherein said latch and said cover form two linear bearings between them.

10. The floor drain according to claim 8, wherein said linear bearing comprises a cover-side elongate hole and a latch-side bearing part.

11. The floor drain according to claim 1, wherein said latch is equipped with at least one operating means.

12. The floor drain according to claim 11, wherein said at least one operating means is one of two operating means.

13. The floor drain according to claim 11, wherein said operating means is a portion of said latch protruding from said cover.

14. The floor drain according to claim 13, wherein said operating means protrudes from a leg of said cover.

15. The floor drain according to claim 1, wherein said latch is equipped with an auxiliary mounting means.

16. The floor drain according to claim 15, wherein said auxiliary mounting means comprises two elastic arms each with a free end, and wherein a latch-side bearing part and a wing is attached at each free end of said arms.

17. A method for installing a floor drain, which method comprises:
providing a floor drain according to claim 3;
placing the cover on the adjusting screw or screws in the drain channel, wherein the latch is in a first, unfixed state; and
displacing the latch into a fixed state by displacing the one or more operating means toward the adjusting screw.

18. A method for de-installing a floor drain according to claim 3, the method which comprises the following steps:
displacing the latch into an unfixed state by moving the one or more operating means away from the adjusting screw; and
removing the cover from the adjusting screws or screws out of the drain channel.
